(19) United States
(12) Patent Application Publication
(10) Pub. No.: US 2007/0214045 A1
(43) Pub. Date: Sep. 13, 2007

(54) SYSTEM AND METHOD FOR OPERATING A MARKETPLACE FOR INTERNET AD MEDIA AND FOR DELIVERING ADS ACCORDING TO TRADES MADE IN THAT MARKETPLACE

(75) Inventors: Anand Subramanian, New York, NY (US); Shanthi Sarkar, New York, NY (US)

Correspondence Address: DARBY & DARBY P.C., P.O. BOX 770, Church Street Station, New York, NY, 10008-0770, US

(73) Assignee: ContextWeb, Inc., New York, NY (US)

(21) Appl. No.: 11/627,902

(22) Filed: Jan. 26, 2007

Related U.S. Application Data
(60) Provisional application No. 60/762,980, filed on Jan. 26, 2006.

(51) Int. Cl. G06Q 30/00

(52) U.S. Cl. 705/14

(57) ABSTRACT

A method and system to operate an Internet-based exchange that offers commoditized Ad Media. The system receives the identity of Ad Media from a publisher, automatically classifies the Ad Media so as to associate the classified Ad Media with other like Ad Media and groups the associated Ad Media into buckets forming a commoditized Ad Media, which is offered for purchase or sale over the Internet as tradable units on the exchange. The system includes a media ownership rules module, containing business rules, in communication with a media trades record module containing records of ownership interests, a classification module, an ad server registry module containing configuration information specific to a plurality of ad servers, and a tag routing module that receives ad requests for advertisements from an Internet browser and forwards the ad requests back to the Internet browser for rerouting to an ad server.

### CLAIM OF PRIORITY

This application claims the benefit of priority, under 35 U.S.C. § 119(e), of U.S. Provisional Application No. 60/762,980, filed Jan. 26, 2006, and titled “System and Method For Operating A Marketplace For Internet Ad Media And For Delivering Ads According To Trades Made In That Marketplace,” which is hereby incorporated by reference in its entirety.

### FIELD OF INVENTION

The present invention relates to managing and delivering Internet advertising, and more particularly to managing a marketplace where producers and consumers of Internet ad requests can buy and sell groups (i.e., buckets) of these requests according to dynamic market prices.

### BACKGROUND OF THE INVENTION

Standard producers of online ad-request inventory are publishers. They own or operate websites that users visit using web browsers, and they allocate space on those pages where advertisements may be added. Consumers of online ad-request inventory are Advertisers. They offer products or services online, and they create advertisements for those offerings which they desire to show to Internet users. Those advertisements are then added into the publishers' pages so that users see them as they browse. Each time an individual user browses to a publishers' page that contains pre-allocated space for advertising, an Ad Request to deliver an ad to fill that allocated space can be made to an Ad Server either by the user's browser or by the Publisher.

Publishers are able to predict in advance approximately how many times in a given day or month a user will browse (or request to view) one of the pages on their site. By combining this prediction with the knowledge of which page spaces have been set aside for advertisements, Publishers can estimate how many advertisements will be shown to users visiting their site in a given period of time. The accuracy of this estimate depends on such factors as the publisher, its typical volume of user page views, behavioral patterns of that user base, and the granularity of the analysis, and other factors that serve as a metric of activity. Because Publishers are paid for allowing parts of their pages to be filled with advertisements, this estimate of future ads to be shown may be considered an asset owned by that Publisher. As with any other asset, this asset can be sold to advertisers or their agents. The asset can be called an Ad Request Inventory or Ad Media. Advertisers and/or their agents who buy this inventory may be called media buyers. Publishers and/or their agents who sell this inventory may be called media sellers.

When the Ad Media is considered in terms of the number of expected ad requests, the inventory is typically quantified as a particular number of Ad Impressions. Ad Impressions are priced as a Cost-Per-Thousand Impressions (“CPM”). Additionally, because a click may or may not result each time an ad is shown to a user, inventory may also be quantified as a particular number of expected Ad Clicks, and could be priced as a Cost-Per-Click (“CPC”). Inventory also may be quantified and priced in other standard ways known to those in the relevant art, such as a number of Conversions and a Cost-Per-Action (“CPA”) which measures the advertising cost per users who purchase or subscribe to the advertised product or service.

Prior to buying Ad Media, i.e., advertising space on a webpage, media buyers place their advertisements into a specialized system called an Ad Server. An Ad Server selectively delivers one or more of the ads placed by the media buyer in response to requests made to the Ad Server. The Ad Server provides the Media Buyer with a small piece of industry-standard software called an Ad Tag. Upon its execution, the Ad Tag sends a request to the ad server to deliver one or more of the media buyer's ads.

When media buyers buy Ad Media they often provide the same Ad Tag, or a slightly modified version, to the media seller and/or publisher. The media seller assures that the Ad Tag is executed according to the contracted terms of the sale, i.e., user geographic locations, time of day, specified date range (“flight dates”), quantity, and other parameters. Among these contracted terms may be a categorization of the pages where the ads are to be shown. Categorization allows media buyers to buy Ad Media across a group of publishers on the basis of a number of impressions, or clicks, etc., in particular a category or categories. For example, a bank wishing to advertise its mortgage programs can restrict the display of its ads only to pages categorized as Finance-related, or Home Finance-related. Targeting an ad placement in this manner allows media buyers to spend ad budgets more efficiently. Also Ad Media is not wasted showing unrelated ads.

When advertisers purchase distribution for their ads on a website or set of websites, there are a few standard ways they can pay for that. The simplest models are:

1. A fixed cost per thousand impressions (“CPM model”). If an advertiser pays a fixed rate CPM (e.g., $1.00), they pay the fixed rate of $1 for every thousand times their ad is shown (impression), regardless of user response rate to that ad.

2. A fixed cost-per-click model (“CPC”). If an advertiser pays a fixed rate (e.g., $1) CPC, they pay $1 every time a user clicks on that ad, regardless of the number of times the ad is shown without being clicked.

3. A fixed cost-per-action model (“CPA”). If an advertiser pays a fixed rate (e.g. $5), they pay $5 every time a user either purchases the product being advertised, or signs up for the service being advertised, or takes whatever positive action being advertised for users to take, regardless of the number of ad impressions or clicks.

However in many situations the market value of ad space may vary. For example, if the ad is to be matched to a keyword on an active search page or in contextual advertising, then the value of that ad space depends on the market value for that keyword (e.g., “casino” is typically more valuable for advertising than “paper”).

As a result, auction models have become common. In such a case advertisers bid on how much they're willing to pay—typically on a CPC basis—to have their ad shown on those pages, against that keyword or context, etc. An ad server implements the placement algorithm and is able to maximize the value of that ad space by selecting the highest paying ads at any given time. In some cases the ad server will also combine performance data for that ad (including click-through-rate (“CTR”) data, for example) with the bid price per click to determine the effective CPM (“eCPM”) rate for each ad, and then choose the highest eCPM ads. The eCPM may also be combined with purchase or other conversion data to establish a cost per action (“CPA”), and then include CPA values in the selection process. In either case the ad selection formula typically relies on an auction-based marketplace. The term eCPM is an industry standard known to persons of ordinary skill in the art. As is readily understood by a person of ordinary skill in the art, CPA is also known as cost-per-conversion, or cost-per-sale.

The eCPM value reflects what the equivalent CPM is if the pricing model is based on CPC or some other non-CPM model. For example, a CPC rate multiplied by the ad's click-through-rate multiplied by 1000 yields the eCPM for that ad based on its response.

$$eCPM = CPC * CTR * 1 \text{,} 000 ; or eCPM = \frac{Cost}{Click} * \frac{Click}{Impression} \times 1 , 000$$

Further insight into these topics can be found in pending U.S. patent application Ser. No. 11/502,751, titled “Method and System for Placement and Pricing of Internet-Based Advertisements or Services,” filed Aug. 11, 2006 with common inventors and assigned to the same entity as the present invention. U.S. patent application Ser. No. 11/502,751 is hereby incorporated by reference in its entirety.

The ability to buy and sell media by category is a feature of the current online advertising market. Categorization adds value, and makes it possible for media sellers to demand higher prices (e.g., CPM or CPC). The demand for well categorized media implies demand for scalable categorization processes. Prior art processes include both manual and automated approaches. A manual approach has human editors reviewing publishers' sites to categorize the whole site, either to a particular category, or to categorize different areas of the site to various different categories. This process can easily become labor intensive requiring a large number of human editors. This approach quickly becomes untenable on pages that contain dynamic content—e.g., online newspapers or blogs where content may be on different subjects on different days. For dynamic content, human editors cannot logistically keep up with re-reading the content of these pages and changing their categorization decisions.

U.S. Published Patent Application No. 2002-0123912-A1, titled “Internet Contextual Advertisement Delivery System and Method” to Subramanian et al., automates approaches to media categorization that are more scalable for both static content and dynamic content situations. However, even with effective automated categorization systems, the burden remains on media sellers to choose among the available automated and manual approaches. This choice results in the presence of a confusing mix of approaches in the advertising market, thus further increasing the burden on media buyers to work with a multitude of approaches and manage quantities of inventory bought from each seller in each model. U.S. Published Patent Application No. 2002-0123912-A1 is hereby incorporated by reference in its entirety.

Another problem present in the prior art models affects the media buyers' experience in monitoring the performance of their media buys. In order to monitor the effectiveness of their media buys, media buyers receive regular reports on the number of ad impressions, clicks, conversions, etc. delivered each day, month, etc. However, for media buys that are not site specific, media sellers rarely if ever report which particular Publishers' sites ran the media buyer's ads. Often within a media-buy there are some Publishers' sites where the ads are effective, and some sites where the ads are ineffective. Similarly, within an uncategorized or run-of-network media-buy there will often be one or more categories that are effective and one or more that are ineffective. Even within a categorized media-buy there will often be one or more sub-categories that are relatively effective, and one or more that are relatively ineffective. However, media buyers have no mechanism to determine which part of their buys are the effective parts. Additionally, even if the effective buy parts are known, media buyers can not act on that knowledge because media often cannot be bought at the next level of granularity (e.g., sub-category level or site-specific).

Missing from the art is a mechanism to create a standardized marketplace where parties can meet to buy and sell media according to free-market prices and a standard categorization approach. The present invention can satisfy one or more of these and other needs.

### BRIEF DESCRIPTION OF THE DRAWING FIGURES

FIG. 1 depicts an illustrative embodiment of the high-level ownership and trading dynamics that are present in an embodiment of the present invention;

FIG. 2A depicts a first portion of an embodiment of a system that is in accordance with the invention;

FIG. 2B depicts another portion of an embodiment of a system that is in accordance with the invention;

FIG. 3 illustrates a process in accordance with the embodiment of FIGS. 2A and 2B;

FIG. 4 depicts an illustrative embodiment of a market accessor tool in accordance with the invention;

FIG. 5 depicts an illustrative report generated by an embodiment of the present invention;

FIGS. 6A-B illustrate two conventional approaches for delivering advertisements;

FIGS. 7A-B depict other portions of the embodiment depicted in FIG. 2A;

FIG. 8A-B depict other portions of the embodiment depicted in FIG. 2A and

FIG. 9 depicts another embodiment of a market accessor tool.

### DETAILED DESCRIPTION OF THE ILLUSTRATIVE EMBODIMENTS

By way of overview and introduction, presented and described are embodiments of a method and system that manage a marketplace where parties may buy, sell, and manage Ad Media; as well as manage categorization and delivery of ad requests according to specifications provided by the respective owning parties (e.g., publisher or advertiser or agents thereof). While publishers and advertisers are users of the system embodying the present invention, an end-user is the target of the advertising and is typically an individual accessing a web page and reading its content and advertisements.

Different embodiments interrelate the following elements:
1. A set of publishers, each representing a property (i.e., advertising space on a webpage), a network, an aggregation of properties, that contains pages where ads may be shown.
2. A set of advertisers, each owning one or more advertisements that the advertiser wishes to have displayed to end-users under certain defined conditions.
3. An Ad Media exchange marketplace (herein referred to as “exchange marketplace or “exchange” interchangeably and without differentiation), where parties may buy and/or sell media with each other according to free market prices, using standardized or customized tools.
4. An inventory of Ad Media, comprising a projected quantity of ad requests to be filled as users request and view publisher pages, where the pages contain space available for advertising
5. A set of media traders (e.g., media buyers and/or sellers), each able to transact media purchases and sales on the marketplace of the present invention
6. A media classification module, which is operable to perform real-time classification of the ad requests comprising the inventory of Ad Media. The module is implemented in hardware, software, or a combination thereof, and is operative in a computer-based Internet capable system.
7. A set of media “buckets,” each comprising a part of the complete Ad Media inventory managed by the system, where each bucket contains a quantifiable inventory of media. Each member of the Ad Media inventory has the same properties (e.g., such as page category, publisher site, time of day or month or year, and geographic location of the end-user), or a subset thereof being a constituent of the bucket.
8. A set of market accessor tools, each such tool enabling its user to perform a combination of: 1) transacting business (e.g., placing buy and sell orders) on the marketplace embodying the present invention; 2) viewing available media buckets, their properties, quantity available, and current market prices; and 3) viewing and managing media currently owned by that user or the party he represents. Additional information and tools may also be provided by these tools such as detailed status of executed trades that are currently partially fulfilled. By way of example, if the trader has executed and cleared a buy order for up to one million impressions in a particular media bucket to be delivered during the month of February 2007, on February 10th the market accessor tool can show partial delivery and prorated charges according to ad requests routed to his ad server by the exchange during the first 10 days of the month. The market accessor tool can be implemented as hardware, software or a combination of hardware and software.
9. A tag routing module able to receive, classify (via the classification module) and route ad requests in real time to the ad server(s) specified by media owners.

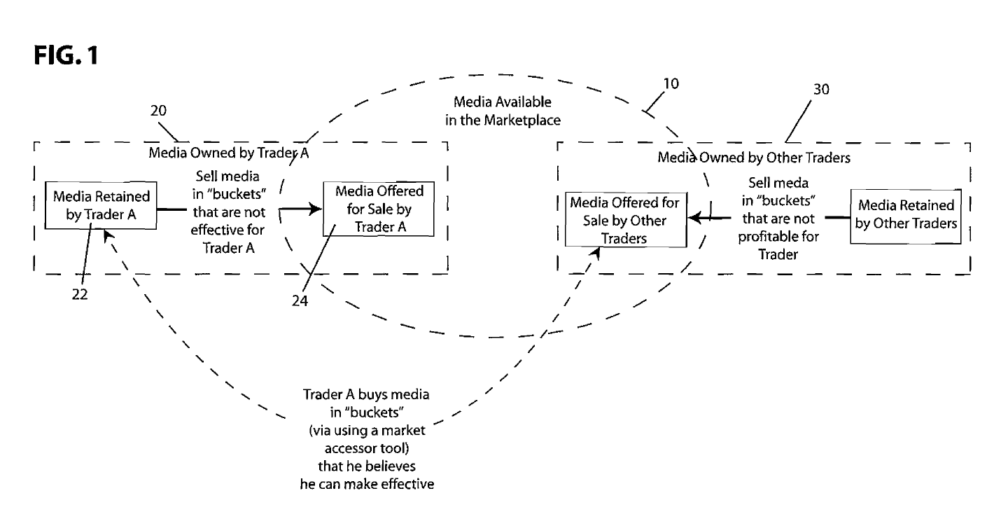

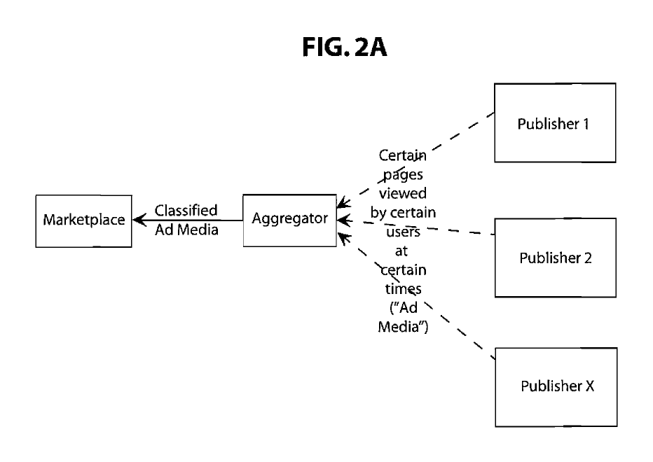

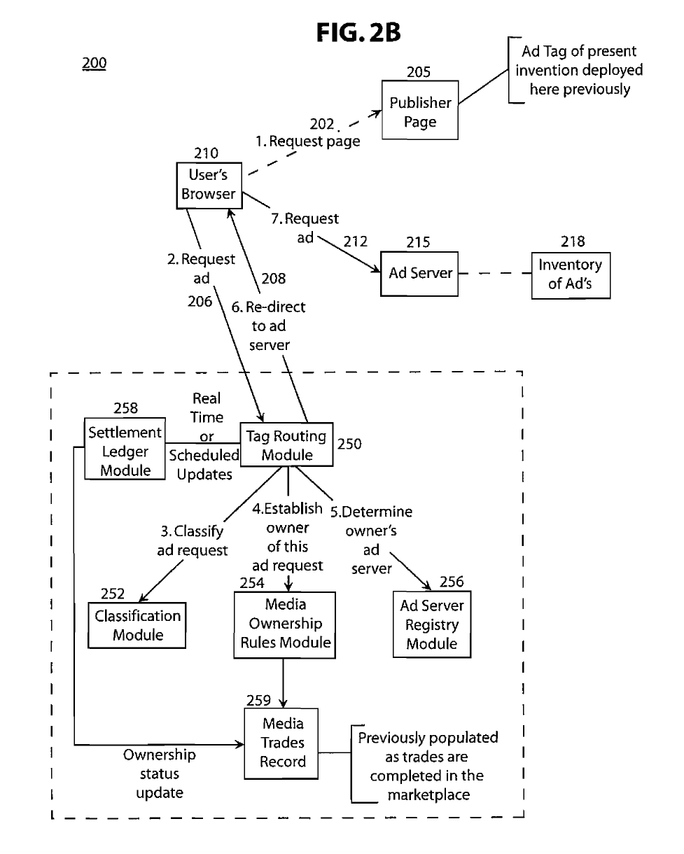

FIG. 1 illustrates the high-level ownership and trading dynamics relating to the open marketplace 10 where media buying and/or selling activities are carried out by parties interchangeably in order to optimize their owned-media for certain ad campaigns. FIG. 1 depicts an individual media trader (media buyer and seller), Trader A, who owns an inventory of classifiable media 20. The classifiable media can be processed by a classification module 252 as shown in FIG. 2B. The media owned by Trader A includes an effective portion 22 and an ineffective portion 24. Trader A retains the parts or “buckets” that are effective 22 and offers the ineffective parts or “buckets” 24 for sale to other traders 30 in the market place. A person of ordinary skill in the art will readily understand that the media buckets or classifications that are ineffective to Trader A might be more effective for the other traders 30 offering other products or running different ad campaigns. Furthermore, Trader A is able to grow an inventory of effective media 22 by observing the classifications of the effective media, and placing orders in the marketplace to purchase more media having that classification.

The orders placed by Trader A can be filled with media that in turn is offered for sale by other traders 30 for whom that media classification (or “bucket”) has proved ineffective. Thus, what might be ineffective for Trader A could be effective for other traders 30, and vice a versa. Free market pricing is an exemplary pricing model that allows market price to be determined based on supply and demand. Buyers may raise price offers or bids when not enough supply is offered, and sellers may lower price offers when there is not enough demand.

FIG. 2A depicts one portion of an embodiment of the present invention where an aggregator consolidates Ad Media from many sources, Publisher 1, Publisher 2, Publisher X. By classifying like Ad Media the aggregator creates buckets of commoditized Ad Media that can be bought and sold as an individual tradable unit, or a quantity of units, on the marketplace. Once classified and commoditized these tradable units can have different market values depending on their classification, and can obtain higher market value in comparison with unclassified or more broadly classified units. These commoditized media units are fungible within their category, and are tradable as such in the exchange marketplace embodying the invention. The aggregator, or entities operating the exchange marketplace, can generate revenue for themselves by charging transaction fees to traders on executed trades, either on a flat rate or a percentage of finds transacted basis.

Fees may also be charged to media owners according to the volume of ad media or traffic directed for delivery to that owner via the tag routing module 250 of FIG. 2B. This volume can be quantified, for instance, as a fixed-rate fee per thousand impressions delivered, or per user click, or response to an exchange-delivered ad unit, or per purchase or conversion, and it will be understood by those familiar with the art that there are other standard ways for the exchange operator to generate revenue for itself through fees proportional to the volume delivered.

The exchange operator can also charge fees by charging traders for each seat or account permitted to trade on the exchange platform. Exchange operators may create asset accounts for each trader, where each account can carry a combination of cash, credit, and assets in the form of sellable Ad Media. Fees such as described above may be charged via debits applied to these accounts.

The commoditized media units can be a conglomeration of Ad Media from one or multiple publishers, different web pages located at the same or different websites, related by context, related by end-user criteria such as demographics or internet connection attributes (e.g. browser type and configuration, internet connection speed) or geographic location, or the number of times the page has been seen by that user in a recent time period (related by day, date, or time of day, and/or any combination thereof). As is readily apparent to persons of ordinary skill, other rules for classifying the various components of the commoditized media unit can be devised and would be within the spirit and scope of the present invention. As an example, the commoditized media unit can be a category of Ad Media from multiple web pages that provide reviews of computers, computer peripherals, and computer software. These commoditized units can at the same time be restricted to media requests from west coast end-users who might visit the sites within the allocated ad space on a particular day, or time. The commoditized unit would be associated with a quantity of Ad Media bought and/or sold in the marketplace. In the exchange marketplace of the present invention there are available multiple units of the same commoditized unit.

In one embodiment, the contents of each commoditized unit category are unknown to the purchaser of the unit category, as the commoditized units are traded on the exchange marketplace “site blind.” Being “site blind” keeps the identity of the web page publisher hidden. This is done so that publishers who sell their Ad Media through conventional channels at higher prices can still offer remnants of their Ad Media on the exchange marketplace without impacting the pricing of the conventional market.

However, tools are provided by the exchange marketplace so that advertisers can evaluate the effectiveness of a particular commoditized unit category. This gives advertisers visibility into their ad campaign by sub-category, and thus, ineffective commoditized unit categories are identifiable by the advertiser, and can be offered back on the exchange marketplace for sale to another.

FIG. 2B depicts another portion of system 200 which supports the exchange marketplace between media buyers and/or sellers. System 200 provides a standardized marketplace where parties can meet to buy and/or sell media according to free-market prices and a standard categorization approach. A party who buys media in one transaction can later sell a portion of that same media-buy to another party. Thus, one party can be both a buyer and a seller. Each party who buys and/or sells media in this marketplace is provided a standard tool for viewing and managing currently owned media, their pending buy and/or sell orders, the media which is currently offered for sale, and the requests for media purchase in the marketplace. They may also view details of their past executed trades that are currently partially fulfilled by viewing intra-month delivery statistics and proportional charges. The tools are standardized for all parties and the marketplace platform uses a consistent automated media categorization scheme. Due to this consistent categorization scheme, user-customized tools are also within the contemplation of this invention. This approach streamlines marketplace transactions and provides clear visibility of the effectiveness of each media owned by a party utilizing granular metrics to the level the market demands.

Beyond being a marketplace for buying and/or selling media and managing owned media, the system 200 also includes a delivery aspect. The system can broker ad requests generated for media transacted on the marketplace platform by performing real-time categorization of each request. By brokering the request, the system identifies the media buyer who owns the ad request and associates the appropriate Ad Tag (i.e., the Ad Tag registered in the system to that media buyer). This association by the system results in the ad request being routed to the media buyer's desired Ad Server. Thus, the system can cause the actual delivery of the advertisement.

In the case of trades that are defined as Settled-On-Delivery, this real time routing process also interfaces with a settlement ledger module 258 of FIG. 2B that records both real time, or near real time, ad-request delivery statistics, and corresponding aggregate charges for debiting to the account of the trader account who received each ad request.

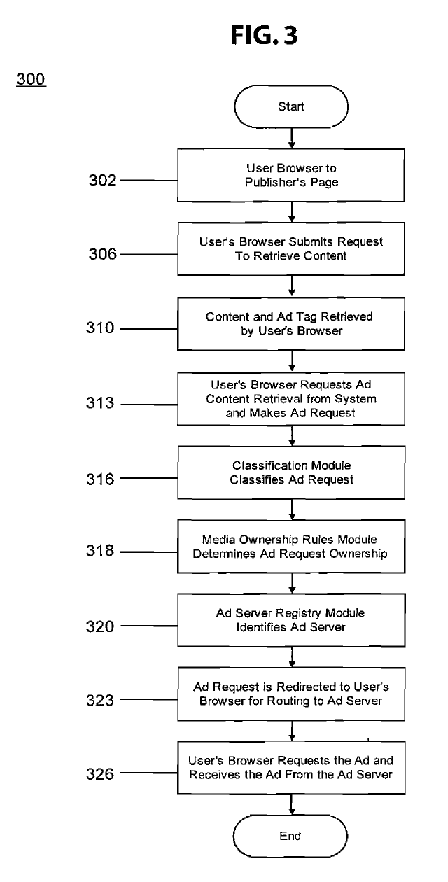

FIG. 2B illustrates a system 200 embodying the present invention configured to deliver ads to fill the media that has been sold in the marketplace. FIG. 3 illustrates a process 300 in accordance with the embodiment of FIGS. 2A and 2B. A description of system 200 and process 300 follows. At step 302, an end-user browses the Internet using a web browser 210 and arrives at a page 205 owned by a publisher who has sold media on the marketplace. The publisher page 205 includes an Ad Tag placed by the publisher and related to the media buyer as discussed above. The user's web browser 210 submits a request 202, step 306, to the publisher's page 205 to retrieve the content of that page. At step 310, the publisher's page content and the Ad Tag are sent to the user's browser 210.

The user's browser executes the Ad Tag retrieved with the content of the publisher page, causing an ad request 206 to be made, step 313, to the system 200 to retrieve ad content. The classification module 252 classifies, step 316, the ad request 206 into one of the buckets defined in the marketplace. At step 318, the media ownership rules 254 are consulted to determine ownership of ad request 206. In one embodiment the media ownership rules are updated after trades are executed in the marketplace. These updates can be made continuously as the trades are executed. As soon as is practicable, the fulfillment of a trade's quantity can be reflected in the system's routing decisions. Similarly, if a trade's quantity is close to being fulfilled, or not close to being fulfilled, the system can route a higher or lower percentage of ad requests in that category to that party accordingly.

Process 300 continues at step 320, where the ad server registry module 256 identifies, based on the owner of the ad request 206, which registered ad server 215 has the responsibility to deliver the ad content 218 to the user. The ad server 215 is registered by the media owner with the system 200 and entered into the registry module 256 prior to completing the purchase of that media in the marketplace.

The tag routing module 250 routes, step 323, the ad request 206 to the ad server 215 identified by the ad server registry module 256. This routing can be accomplished by sending a redirect instruction 208 back to the user's browser 210. The user's web browser 210 then requests and receives, step 326, an ad from the ad server 215. The ad server pulls the ad from its own ad inventory 218.

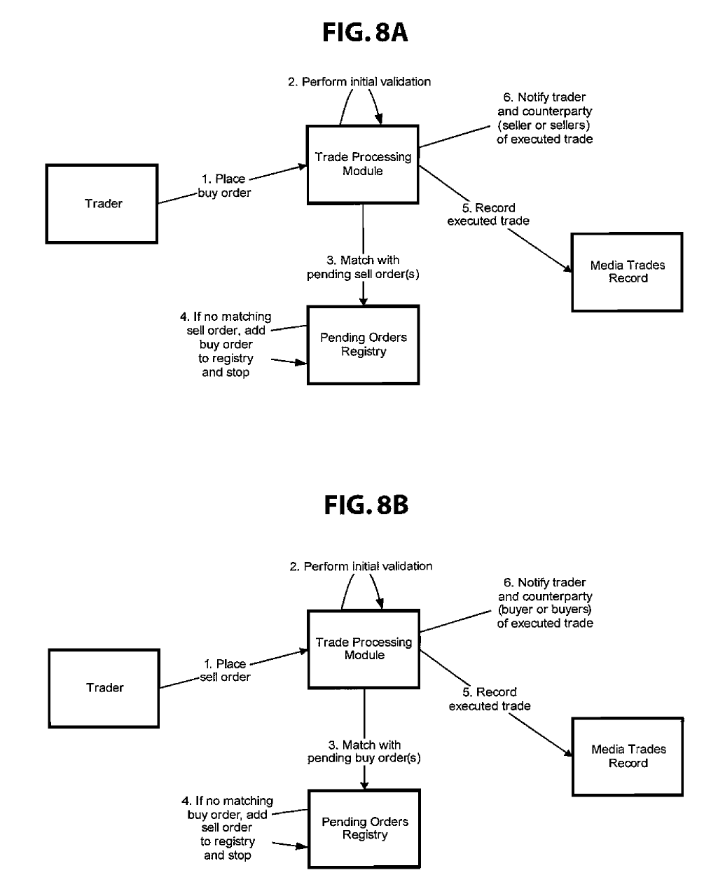

Also shown in FIG. 2B is a Media Trades Record Module 259. The Media Trades Record Module integrates trades executed on the exchange marketplace with the ad request routing described above. With reference to FIGS. 8A and B, the Media Trades Record Module receives and makes a record of each trade (whether buy or sell) on the exchange marketplace. System 200 also interfaces with the Media Trades Record Module. To route an ad request, the Tag Routing Module 250 accesses the Media Ownership Rules Module 254 to determine which media buyer owns the Ad Request and has the right to deliver advertisements in response to that request. The Media Ownership Rules Module 254 queries the Media Trades Record to determine the media owner, and just how much ad-request inventory of this type the owner still has a right to receive. In one embodiment, the amount of Ad Media ascribed to a particular media buyer is decremented as ad requests are routed to its server through the efforts of the Tag Routing Module 250.

Once the identity of the media owner is determined, the Ad Server Registry Module 256 acts to associates the ad request with the correct ad server for that media owner. The Registry Module 256 contains the technical details on how the ad request redirection instruction should be constructed for routing to the media owner's ad server. When these ad requests are routed over the Internet they typically use the HTTP protocol, such that the redirects are sent as 300 or 302 response codes from the tag router module to the user's browser. On that redirection response the tag router includes the full URL including any querystring parameters or HTTP post data according to the technical data registered in the Ad Server Registry Module. That registry module can therefore include each ad server's address as well as URL construction information such as generalized querystring and post data parameters. It is also within the spirit of this invention that the ad requests or redirections may be made using richer protocols such as SOAP, REST, or other web services protocols built on top of HTTP. The particular details are not limiting to the invention, so long as the ad request is properly formatted to continue to the correct ad server when it is forwarded back to the user's browser 210, as described above.

FIG. 2B also depicts a Ledger Module 258 in communication with the Tag Routing Module. As ad request redirections are sent to the user's browser, the Tag Routing Module 250 can send notice to the Ledger Module 258. These notices can come from the Tag Routing Module 250 in real time as the ad request is forwarded, or can come at scheduled intervals. The Ledger Module 258 tracks the notices for each ad media buyer for billing purposes. In one embodiment, for instance, billing can be done incrementally as an ad request is forwarded out of the Tag Routing Module. Billing can also be done once a preset threshold is reached, or on a time dependent criteria (e.g., hourly, bi-hourly, daily, etc.). The Ledger Module can also track these notices and develop information on the publisher receiving the advertisement, so that revenue for the exchange marketplace operator can be generated by billing both the Ad Media buyer and seller.

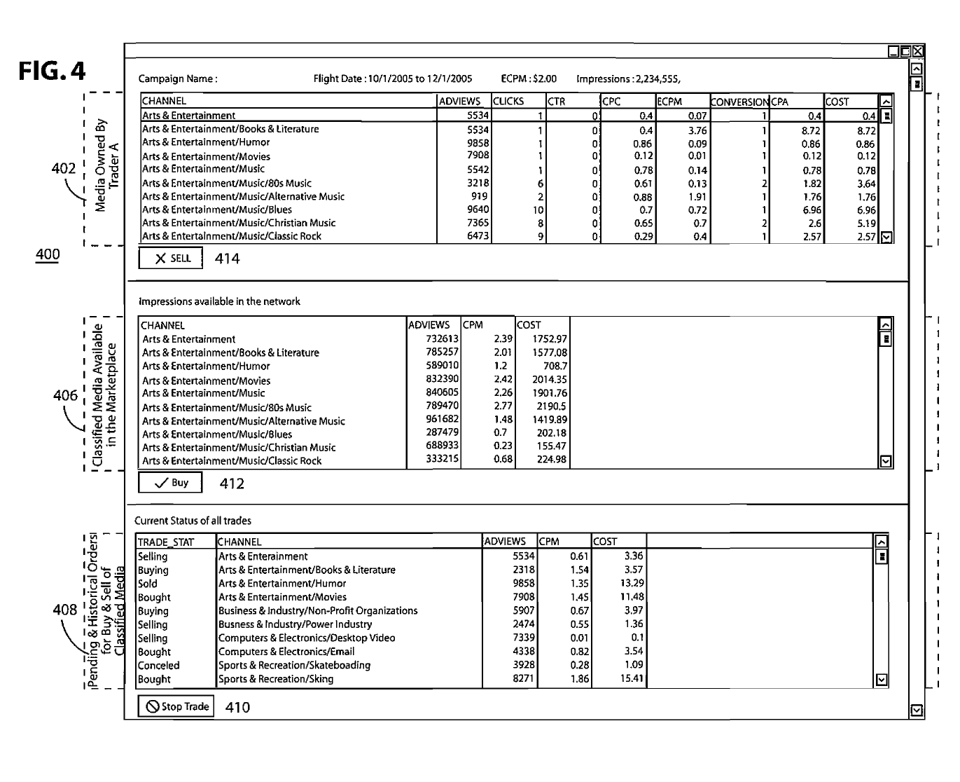

An embodiment of the invention enables media traders to transact business in the marketplace by use of marketplace accessor tools. FIG. 4 depicts an interactive display 400 of an embodiment of the market accessor tool.

The software application that presents the interactive display 400 enables media traders to view all currently owned media 402. The media can be grouped by bucket or classification 404 (labeled “channel” in FIG. 4), and optionally filtered by one of a multitude of ad campaigns currently managed by the media trader. The attributes that define each bucket or classification are visible, as are performance statistics for the ads that have run in a particular period of time. Examples of these attributes include, but are not limited to, the contextual category of a currently viewed page, a part thereof, or other pages related by links, etc.; the domain name of the currently viewed page's address; an account number or identifier assigned to the publisher when they subscribed to the system; the geographic location (e.g., country, state, zip code, etc.) of the user requesting the page; demographic information (e.g., age, gender, interests, background, etc.) of the user requesting the page; information about when the page was requested by the user (e.g., time-of-day, day-of-week, day-of-month, season of year, etc.).

The media trader may review these groupings and statistics to determine the effective media and the ineffective media for this campaign. For instance, information is presented regarding the CTR (click-thru-rate), which is a measure of how many viewers of the advertisement click on the embedded link to visit the advertiser's webpage. Also provided is information on the Conversion (how many viewers bought product from the advertiser), and the Cost (a measure of how much the advertiser paid for these results). The media trader may offer to sell a quantity of media in the marketplace by highlighting a row and clicking the “sell” button 414. At that time a prompt appears to specify additional details about the sell order (not shown in the figure) such as the exact quantity to sell, and if the offer is more than market price then also the offered price and length of time to keep that offer open on the market.

Additionally, the interactive display 400 allows media traders to view all media currently offered for sale 406 by other parties in the marketplace. The same standardized classification semantics are used here as are used for the inventory owned by the media trader. Each bucket shows quantity available and asking price. The media trader is able to review this data to dynamically identify whether the marketplace contains media desirable for purchase. The data also permits consideration of whether to sell certain media by reviewing market prices versus the current effectiveness of that media for the media trader. If the media trader wishes to buy media, a buy order can be submitted to the exchange by highlighting the group and clicking the “buy” button 412. At that point the media trader can be prompted to specify additional details about the buy order (not shown in the figure) such as the exact quantity to buy, and if the offer is less than market price then also the offered price and length of time to keep that offer open on the market.

Further the interactive display 400 enables users to review currently pending and recent historical trade orders 408, with the ability to take certain actions on those orders such as canceling a pending order by clicking the “stop trade” button 410.

Other embodiments and implementations of the market accessor tool, consistent with the purpose of empowering users (e.g., traders and other actors in the marketplace) to transact business in the marketplace and to carry out other management and analysis activities related to the marketplace, are within the scope and spirit of the invention.

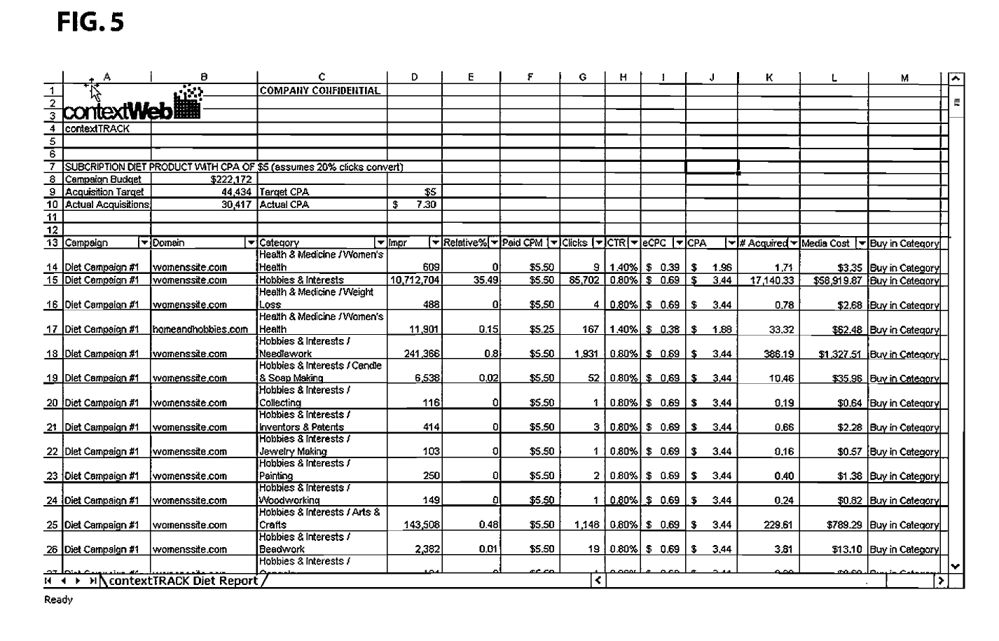

FIG. 5 shows an illustrative report generated by an embodiment of the present invention. Each ad campaign is listed along with the category of commoditized unit in which it being placed. Metrics are also provided to show the effectiveness of the ad campaign correlated to each of these commoditized units. Each trader (media buyer/seller) is granted access to use a market accessor software tool. The tool, an interactive GUI, enables the trader to view market inventory and prices, to place buy and sell orders in the marketplace, to view records of their completed trades, to view pending orders in the marketplace, to view their own currently owned inventory, to view historical performance of their media by category (classification), to use analytical tools related to the marketplace and to view their owned media. Other features aiding in the determination of the effectiveness of an ad campaign are also contemplated by the present invention to be a function/feature provided by the market accessor tool(s). The report shown in FIG. 5 is an exemplar of a performance report generated by a market accessor tool, and then viewed in a spreadsheet tool like Microsoft Excel.

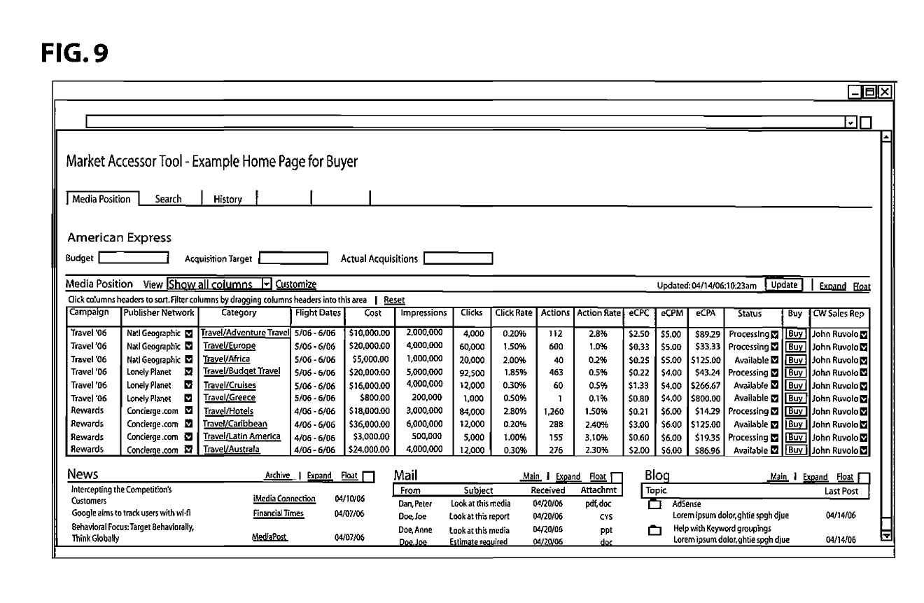

FIG. 9 depicts another embodiment of a market accessor tool. This embodiment is accessed by the trader visiting an appropriate Web address and logging into his account. Illustrated is a buyer-side detail view, but a seller-side view is equally available. In this view, the trader is a representative of American Express, as shown in the subtitle. The “Media Position” panel displays a list of ad campaigns that are running or scheduled to run. Displayed for each campaign are performance statistics such as number of impressions and clicks delivered by the exchange's Tag Router module in accordance with past media purchases made by this buyer on the exchange. The market accessor tool calculates the click rate from the number of impressions and clicks, and from the number of actions (conversions) the accessor tool calculates the action rate. By basing calculations on the financial cost of the campaign so far, the accessor tool also calculates the effective cost per click (eCPC), the effective cost-per-thousand impressions (eCPM), and the effective cost-per-action (eCPA). A status indicator signals the status of the particular campaign as being either Processing (delivery of ad requests into that campaign is still ongoing and has not yet been completely fulfilled according to the volume purchased), or Available (delivery is complete according to specifications). Ad campaigns indicated as Available can be restarted by clicking the Buy button, and then submitting a new buy order to the exchange marketplace to purchase additional media for that campaign. The accessor tool provides prompts to the user to enter the required information for the buy order (not shown). The “Media Position” panel also displays the name of the sales representative who was engaged to start that campaign. However, the participation of a sales representative is not required for the operation of the exchange or the accessor tools, but is presented in this discussion as an example of an additional type of user and data that can play a role in the marketplace.

FIG. 9 also depicts other related content and services that can be included in the accessor tools to make them more fully featured as a business platform for users. For example, the “News” panel displays recent industry news, which can be received into the exchange system by an electronic news feed, for example by RSS. The “Mail” panel displays an excerpt of the user's email box. The mailbox can be populated with messages from the exchange administrator, or from other traders communicating across a message layer supported by the exchange marketplace. The “Blog” panel is an integrated “web log” or discussion board, posted to and read by exchange members.

As would readily be apparent to a person of ordinary skill, the sell side of this embodiment (not shown) includes tools that are aimed at providing counterpart information of interest to traders on the Sell side. The sell-side view can incorporate features substantially similar to those depicted in FIGS. 4 and 9, including a “Sell” button for active campaigns so that the user can choose the category within the campaign that they'd like to sell.

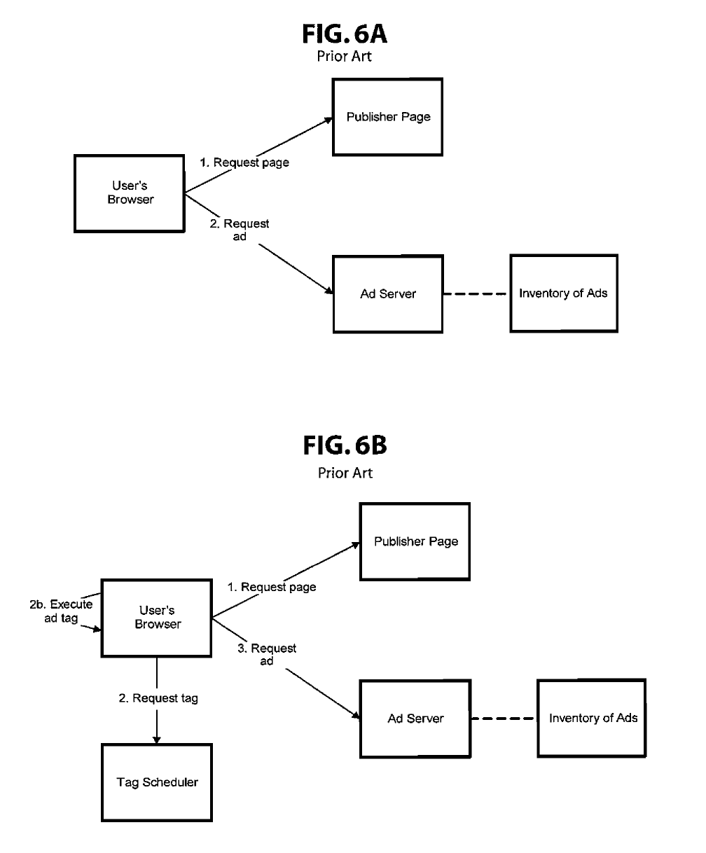

FIGS. 6A and 6B illustrate conventional approaches to delivering advertisements over the Internet to a user's browser. In the simpler approach shown in FIG. 6A, the user's browser requests a publisher's page from a first server, and an advertisement from an ad server connected to an inventory of ads.

FIG. 6B delivers ads using a tag scheduler. “Scheduling” is a term known to ordinary persons of skill in the art, and describes a process that lacks dynamic analysis when an ad tag is chosen for service. In the prior art, multiple ads or ad tags are merely scheduled for delivery from the ad server according to predetermined rules based on certain parameters such as a minimum and maximum number of deliveries per day, or per hour.

As discussed above, the classification module 252 shown in FIG. 2B classifies advertising traffic in real time. The term “ad traffic” throughout the written description means the real time sequence or stream of ad requests generated by users visiting web pages that contain the Ad Tags described in connection with the present invention.

The previously discussed Ad Media can be considered the estimate of future expected Ad Traffic, each of which can be classified by the several embodiments of the present invention. There are many attributes of this ad traffic that can be considered as part of this classification process, as also mentioned earlier. Of these many attributes one attribute that is particularly valuable and lacking in the prior art prior to the invention described in U.S. Published Patent Application No. 2002-0123912-A1 is the contextual category of the traffic, determined by examining the content of the page where the ad is about to be shown. It would also be consistent with this real time contextualization process to consider certain subsections of that page content more than other subsections, and also to consider other pages related to the page requested by the user, those related pages being related for example by hyperlinks present on either page.

This contextual content analysis can be accomplished by the Classification Module 252 submitting real-time requests to publisher sites to retrieve the content requested by the user for viewing in his browser. The Classification Module upon receiving that content analyzes it to determine its category or categories (a.k.a. topic or channel). These categories can be hierarchical so that a page classified as “Entertainment→Sports→Baseball→New York Yankees” may be matched by the Media Ownership Rules Module 254 at any of those category levels depending on available inventory, typically giving preference to those that match at the deeper levels of specificity. Because the quality of ad performance (click-through rate, etc.) is often attributable to the topic of the page, including this contextual category information as part of the classification process makes the present invention a much more highly scalable and effective ad media marketplace and delivery system than exists in prior art. Media ownership rules present in Rules Module 254 are tied to the marketplace and are evaluated by reference to the record of trades completed in that marketplace. The prior art lacks any rules based on any relationship with a marketplace of commoditized Ad Media.

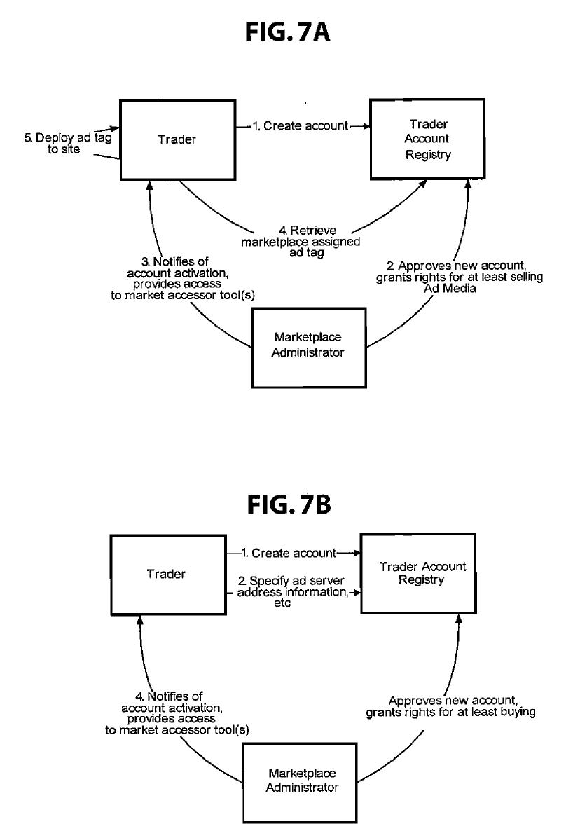

FIG. 7A depicts the sequence that occurs when a trader, for example a publisher, desires to participate in the marketplace exchange embodying the present invention. The trader creates an account by registering, step 701, with a Trader Account Registry which accepts identifying information on the trader. A Marketplace Administrator reviews the new account information and issues, at step 702, an approval to the Trader Account Registry granting the new account at least rights to sell Ad Media in the commoditized marketplace exchange. Naturally, in certain instances the trader may also apply and be granted approval to buy media as well. The Marketplace Administrator, step 703, also notifies the trader of the account activation. At step 704, the trader retrieves a marketplace-assigned ad tag from the Registry. The trader can then deploy the assigned ad tag to its pages, step 705.

Each trader account can carry a certain level of security clearance. These security levels may be requested by the trader and approved by the exchange administrator. A trader account with a low security clearance might be able to see only that trader's owned media but not that offered for sale by others on the exchange. Another level might be able to see all available media on the exchange, but not be permitted to submit trades. Other implementations might have levels able to see reports on their own campaigns' progress toward completion, say by number of impressions versus total expected impressions, but might not have access to other campaign performance metrics such as CTR and eCPM. This flexibility allows a single organization to create multiple accounts, or seats, on the exchange with each having its own level of access to information and actions.

In other embodiments, a Marketplace Administrator need not be involved, and the Registry informs the Publisher of a successful registration. A proxy or agent can also be inserted into the sequence to represent, or stand in place of, either the Publisher or the Marketplace Administrator.

FIG. 7B depicts a further embodiment where the trader, at step 706, provides details to the Trader Account Registry. These details can be used in business rules to be applied by the Media Ownership Rules Module 254 of FIG. 2B. These business rules can include, but are not limited to, block lists (which allow parties to block competitive ads or sites), financial information (such as account deposit requirements, pre-paid, deposit, or credit).

FIGS. 8A and 8B illustrate two alternative embodiments on handling, placing, tracking, and executing orders for Ad Media on the commoditized marketplace exchange. In essence, as with any market exchange of commodities, buy and sell orders are matched and recorded. The parties to an executed transaction are notified automatically, and the trades are “settled” in the sense that ads are placed on the Ad Media within the commoditized units. This matching process does not require that a single buy order be matched to a single sell order or vice versa. For example, a sell order for one million impressions in the category “Travel→Europe” to run in March 2007 can be matched to ten individual buy orders in the same category and time period for 100,000 impressions each. Any combination can be matched and cleared by the exchange, provided the categories and prices match and the quantities add up to the same on both sides.

It is within the scope of this invention that all aspects of modern exchanges can be applied and practiced in this marketplace for commoditized units of Ad Media. These include, but are not limited to, speculative orders, leveraged purchases, puts, calls, limit and market orders, etc. There also can be “market makers” in some or all commoditized ad unit categories. A market maker is a party who is under an obligation to fulfill buy and sell orders placed by traders at the market bid and ask prices.

In an embodiment, the traditional trade settlement process can be modified so that trades can execute (i.e., clear) with variable quantities of ad media (measured in impressions or clicks or so on) specified for the commoditized ad units. The tradable units are, in a sense, futures, i.e., they are guesstimates based on past data on the volume of ad impressions or clicks or conversions that will be available from a source or aggregation of sources in a future time period. The exchange marketplace can classify that traffic but it cannot make the volume predictable. Volume volatility is inherent in the industry, and volatility can increase as classification becomes more granular due to better visibility and discrimination.

Under the prior art, media buyers buy media and then wait for those buys to be fulfilled later with actual traffic. This actual traffic is not always sufficient to fully fulfill the quantity purchased, and the media buyers pay according to actual volume delivered. This is especially true when the media is purchased in a secondary market where other media owners (publishers, as one example) are selling the fraction of media they don't want—i.e., “remnant media.” The exchange marketplace embodying the invention can act as that secondary market. Remnant media is more variable in volume (quantity) than non-remnant.

Traditional exchange models (e.g., stock exchanges) process trades as absolute quantities of products bought or sold, settled within a standard time, for instance three days. The ad exchange marketplace for ad media contemplated by the present invention can settle trades in products that are delivered over time, such that settlement occurs as delivery occurs. For example, at close of each business day, daily delivery statistics can be posted to a settlement ledger that records progress toward complete settlement or fulfillment of all trades.

Accordingly, there can be two types of buy orders identifiable at purchase. One where the buyer specifies a fixed quantity purchased. The other type is where the buyer specifies a ceiling quantity, and he then expects to receive (and pay proportionally for) any quantity from zero to that ceiling quantity.

Billing can be prorated as a percentage of the amount of ad impressions delivered while delivery is ongoing. Trades are executed in advance of the commencement of delivery, and payment is deferred until delivery. As is apparent to a person of ordinary skill in the relevant art, a traditional exchange executing purchases and sales settles right away. Because of the executory nature of the Ad Media, settlement can be separated from the purchase. Thus, settlement must be made over time as delivery is made.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for operating an Internet-based exchange marketplace offering commoditized Ad Media, the method comprising the steps of:
receiving the identity of Ad Media from a publisher for publication of advertisements on a webpage;
automatically classifying the Ad Media according to attributes;
associating the classified Ad Media with other classified Ad Media in accordance with predetermined criteria;
grouping the associated Ad Media into buckets forming a predefined quantity of commoditized Ad Media; and
offering the commoditized Ad Media for purchase or sale over the Internet as tradable units on an exchange marketplace.

2. The method of claim 1, wherein the predetermined criteria is at least one of time dependency, geographic location, and demographic information.

3. The method of claim 1, further including the step of automatically applying business rules in conjunction with the offering step so as to limit the offering steps to recipients based on the business rules.

4. The method of claim 3, wherein the business rules are established as conditions of the purchase or the sale of the tradable units.

5. The method of claim 1, wherein the classifying step occurs in real time as ad requests are received.

6. The method of claim 1, further including the steps of:
receiving an ad request from an Internet browser accessing a webpage associated with that Ad Media; and
routing advertisements for display on the webpage based on classifying the ad request, wherein the classification incorporates the attributes.

7. The method of claim 6, wherein the ad requests are classified in real time.

8. The method of claim 6, further including the steps of:
settling the purchase of the Ad Media through at least one of a real time settlement over the Internet and an incrementally updated settlement; and
storing records of the settlement including purchase and sale information.

9. The method of claim 6, further including the steps of:
querying records of a plurality of purchasers of the offers to determine the ownership interest in the Ad Media among the plurality of the purchasers;
configuring the ad request to incorporate purchaser specific information in the ad request; and
forwarding the ad request back to the Internet browser, wherein the Internet browser then accesses an ad server of the purchaser and receives the advertisement.

10. The method of claim 1, further including the steps of:
storing records of a purchase or sale; and
providing a market accessor tool to the publisher and a purchaser of the commoditized Ad Media, wherein the market accessor tool accesses the stored records.

11. The method of claim 10, further including at least one of the steps of:
providing an ability to utilize the market accessor tool to monitor the effectiveness of an ad campaign based on data in the stored records;
dynamically identifying the existence of Ad Media conforming to a buyer's preference on the exchange marketplace;
placing an order for Ad Media on the exchange marketplace; and
canceling an order present on the exchange marketplace.

12. An Internet-based exchange marketplace for offering commoditized Ad Media, comprising:
a media ownership rules module containing business rules, wherein the media ownership rules module is in communication with a media trades record module containing records of ownership interests in the commoditized Ad Media;
a classification module configured to automatically classify the Ad Media in accordance with predetermined attributes;
an ad server registry module containing configuration information specific to a plurality of ad servers; and
a tag routing module configured to receive ad requests for advertisements from an Internet browser and forward the ad requests back to the Internet browser for rerouting to an ad server;
wherein the tag routing module accesses the classification module for categorization of the ad request, obtains an identity of a purchaser of commoditized Ad Media matching the categorized ad request; and configures the ad request based on requirements of the purchaser within the ad server registry module prior to forwarding the ad request back to the Internet browser.

13. The exchange marketplace of claim 12, further comprising a market accessor tool configured to evaluate the effectiveness of an ad campaign.

14. The exchange marketplace of claim 13, wherein the market accessor tool is an interactive GUI, and is further configured to:
dynamically identify commoditized Ad Media conforming to a buyer's preference;
place an order for the commoditized Ad Media on the exchange marketplace; and
cancel an order present on the exchange marketplace.
